(19) United States
(12) Patent Application Publication
(10) Pub. No.: US 2010/0095089 A1
(43) Pub. Date: Apr. 15, 2010

(54) MULTIPROCESSOR SYSTEM WITH MULTIPORT MEMORY

(75) Inventor: Jin-Hyoung Kwon, Seongnam-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/577,281

(22) Filed: Oct. 12, 2009

(30) Foreign Application Priority Data
Oct. 14, 2008 (KR) 10-2008-0100433

(51) Int. Cl. G06F 12/02; G06F 15/76; G06F 9/06

(52) U.S. Cl. 712/30; 711/149; 711/103; 711/E12.002; 712/E09.003

(57) ABSTRACT

A multiprocessor system includes first and second processors independently executing application functions associated with one or more applications using an open operating system (OS), a multiport memory, a first nonvolatile memory coupled to the first processor via a first bus, and a second nonvolatile memory coupled to the second processor via a second bus. The multiport memory includes a memory cell array divided into a plurality of memory banks including a shared memory bank commonly accessed by the first and second processors via respective first and second ports, and an internal register disposed outside the memory cell array and configured to control access authority to the shared memory bank by the first and second processors, wherein different application functions are independently executed in parallel by the first and second processors using the multiport memory as a data transfer mechanism.

### CROSS-REFERENCE TO RELATED APPLICATION

This application claims priority under 35 U.S.C. §119 to Korean Patent Application 10-2008-0100433 filed on Oct. 14, 2008, the subject matter of which is hereby incorporated by reference.

### BACKGROUND

The present invention relates to multiprocessor systems. More particularly, the invention relates to multiprocessor systems capable of egoistically executing all application functions using any one of the processors in the multiprocessor system and a multiport memory device.

Contemporary mobile communication systems (e.g., multimedia electronic devices such as portable multimedia players (PMP), handheld phones (HHP), personal digital assistants (PDA), etc.) are increasingly implemented in systems utilizing multiple processors. Such “multiprocessor systems” generally run at higher speeds and provide higher end functionality than previous single processor systems. As a result, more sophisticated applications may be run on multiprocessor systems. Such applications enable multiple application functions.

For example, contemporary mobile phones provide basic telephone functions, but also provide an ability to play music, run games, take pictures, shoot video, etc. Thus, processing capabilities once limited to executing a basic telephone application have now been replaced by enhanced processing capabilities sufficient to run much more sophisticated application(s). As a result, a specialized communications processor has been ganged with an application processor within many mobile electronic devices. The communications processor includes specialized circuitry capable of performing such functions as modulation/demodulation. In contrast, the application processor is more general in its capabilities. Accordingly, in this type of multiprocessor system, common application functions are executed on the application processor while communication functions are executed (exported to) by communications processor.

Contemporary multiprocessor systems also require enhanced data storage and retrieval capabilities. The memory devices at the heart of these capabilities must be susceptible to flexile configuration and use in order to facilitate the sophisticated applications being run on contemporary host devices. For example, enabling memory devices commonly include multiple data access ports that may be simultaneously employed by the multiple processors.

Semiconductor memory devices having two data access ports are commonly referred to as dual-port memory. Dual-port memory is well known to those skilled in the art and is often used as video memory adapted to the storage of image data. Conventional dual-port memory includes a RAM port allowing random access to stored data and a SAM port accessible allowing serial or sequential access to stored data. Other multiport memory designs are also used, beyond those routinely associated with video memory. In general, any semiconductor memory device including a plurality of data ports allowing simultaneous access (read/write) to a memory cell array by a plurality of processors will be termed a “multiport semiconductor memory device.” Many multiport semiconductor memory devices provide multipath accessible to a memory cell array.

A range of multiprocessor systems are known in the art. For example, published U.S. Patent Application 2003/0093628 by Matter et al. and dated May 15, 2003 disclosed one conventional example of a multiprocessor system.

Figure (FIG. 1 is a block level diagram of a conventional multiprocessor system. The multiprocessor system 50 comprises a memory array 35 including first, second and third memory array portions. Memory array 35 may be implemented using semiconductor memory devices or a magnetic disk.

The first memory array portion 33 is exclusively accessed by a first processor 70 via a first data port 37. The second memory array portion 31 is exclusively accessed by a second processor 80 via a second data port 38. The third memory array portion 32 may be accessed by either the first processor 70 or the second processor 80 via its corresponding data port. The size of the first and second memory array portions 33 and 31 may be changed in relation to the respective operating loads placed upon the first and second processors 70 and 80.

In order to facilitate common access by the first and second processors to the third memory array portion 32, several system definitions and operating precepts must be established. For example, control over a commonly accessible read/write path must be defined or arbitrated. The structure and organization of memory locations, files, directories, data sectors, etc., must also be defined within the third memory array portion 32.

Thus, memory array 35 is a constituent component of a multiport memory. In the multiprocessor system, respective processors may be assigned to execute different “application functions” (i.e., certain functional components within an application as defined by routine, subroutine, specialty process, etc.). Historically, certain application functions were designated as dedicated application functions assigned to run on only a particular processor (e.g., a telecommunications or modem function). However, with increased host device flexibility and greater user-defined options, many multiprocessor systems no longer enjoy an unrestricted ability to designate certain application functions as dedicated application functions. Unfortunately, providing multiple high-end processors capable of executing every application function drives up the cost of the host device.

### SUMMARY

Embodiments of the invention provide a multiprocessor system capable of egoistically executing all application functions associated with one or more applications running on the multiprocessor system using any one of the constituent processors. Required functions may be executed in parallel by multiple processors accessing a multiport semiconductor memory in an open type operating system. The use of dedicated application functions may be greatly reduced or completely eliminated. Sophisticated applications may thus be executed with greater efficiency and reduced time.

According to an embodiment of the invention, a multiprocessor system includes first and second processors independently executing application functions associated with one or more applications using an open operating system (OS), a multiport memory comprising; a memory cell array divided into a plurality of memory banks including a shared memory bank commonly accessed by the first and second processors via respective first and second ports, and an internal register disposed outside the memory cell array and configured to control access authority to the shared memory bank by the first and second processors; and a first nonvolatile memory coupled to the first processor via a first bus and a second nonvolatile memory coupled to the second processor via a second bus, wherein different application functions are independently executed in parallel by the first and second processors using the multiport memory as a data transfer mechanism.

### BRIEF DESCRIPTION OF THE DRAWINGS

The invention concept will become more fully understood from the detailed description given hereinbelow and the accompanying drawings which are given by way of illustration, wherein:

FIG. 1 is a block diagram of a conventional multiprocessor system;

FIG. 2 is a block diagram of a memory connection structure for another conventional multiprocessor system;

FIG. 3 is a block diagram of multiprocessor system utilizing all of application functions of respective processors according to an embodiment of the inventive concept;

FIG. 4 illustrates a hierarchical structure of operation software referred to in FIG. 3;

FIG. 5 is a block diagram illustrating in detail a multiport semiconductor memory device shown in FIG. 3;

FIG. 6 provides an address assignment and substitutive access relation of internal register and memory banks referred to in FIG. 5;

FIG. 7 is a circuit diagram illustrating in detail an example of multipath accessing to a shared memory bank shown in FIG. 5;

FIG. 8 illustrates an example coupled between a first port unit and a first path unit referred to in FIG. 5;

FIG. 9 is a block diagram illustrating in detail a flash memory shown in FIG. 3;

FIG. 10 illustrates a structure of unit memory cells constituting a memory cell array shown in FIG. 9;

FIG. 11 provides an example of NAND-type memory cell array got by disposing the unit memory cells of FIG. 10 in a string type; and

FIG. 12 is a flowchart illustrating as an example a multi application operation referred to in FIG. 3.

### DESCRIPTION OF EMBODIMENTS

Embodiments of the invention will now be described in some additional detail with reference to the accompanying drawings. The invention may, however, be embodied in many different forms and should not be construed as being limited to only the illustrated embodiments. Rather, these embodiments are presented as teaching examples.

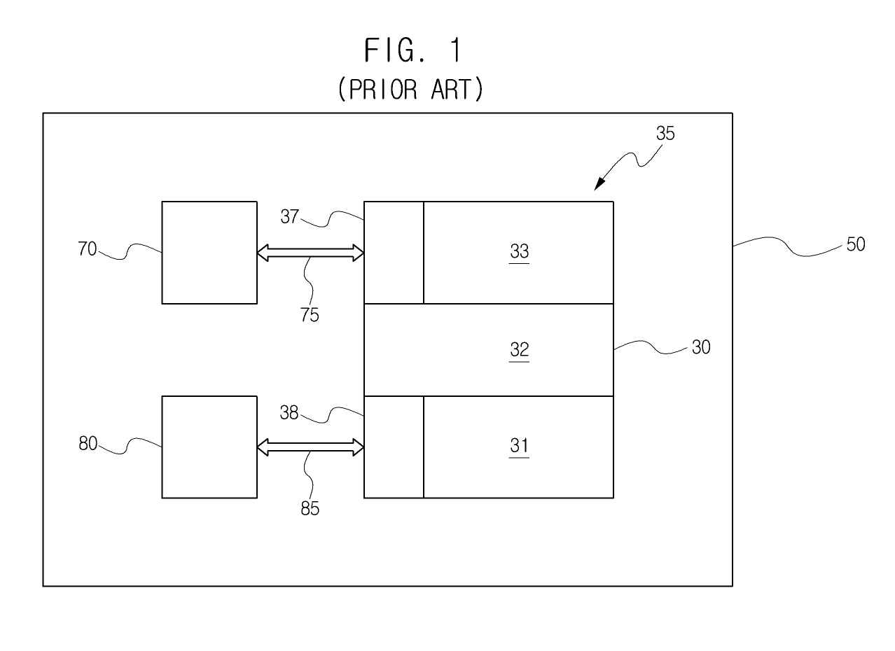

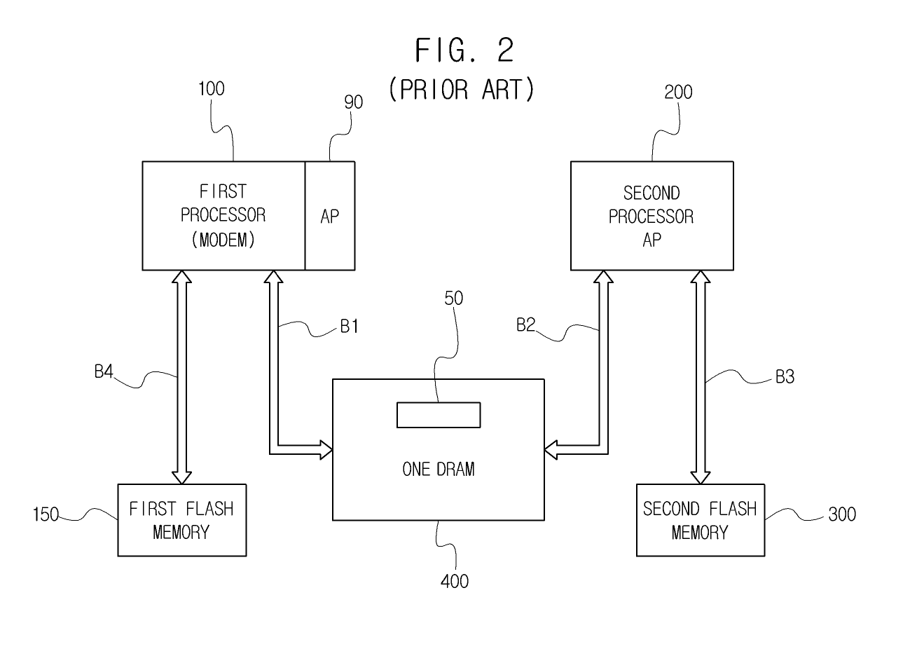

FIG. 2 is a block diagram illustrating the connection structure for another conventional multiprocessor system. This illustrated example is an improvement over the multiprocessor system of FIG. 1 and has been used as multimedia device.

In FIG. 2 the multiprocessor system includes two processors 100 and 200, a multiport DRAM 400, and two flash memories 150 and 300. This multiprocessor system may be used in a mobile communication device (e.g., a handheld phone). The multiport DRAM 400 may be the commercially understood “oneDRAM.” The first and second processors 100 and 200 are configured to share the multiport DRAM 400. The second flash memory 300 is coupled to the second processor 200 via a bus B3. Thus, the first processor 100 may access the second flash memory 300 only indirectly through the multiport DRAM 400 and the second processor 200. In contrast, the second processor 200 may directly access the second flash memory 300.

In the illustrated example of FIG. 2, the first processor 100 is assumed to serve as a MODEM processor performing a range of specialized communication functions (e.g., modulation/demodulation) in relation to a communication signal. The second processor 200 is assumed to serve as an application processor performing most, if not all other functions, unrelated to data communications.

The first and second flash memories 150 and 300 may respectively be NOR flash memory or NAND flash memory. The NOR flash memory and NAND flash memory are both types of nonvolatile memory including an MOS transistor associated with each memory cell floating gate. NOR flash memory and NAND flash memory retain stored data in the absence of applied power. Therefore, these memories are useful in storing (e.g.,) boot codes for portable devices, critical program code, communication protocol code, and other data needed over the life time of the host device.

The multiport DRAM 400 serves as a main memory for data processed by the first and second processors 100 and 200. As illustrated in FIG. 2, each of the dual processor accesses the multiport DRAM 400 via separate access paths (e.g., B1 and B2). The multiport DRAM 400 typically includes memory banks and data ports individually coupled to separate system buses B1 and B2.

As noted above, the multiport DRAM 400 shown in FIG. 2 may be the so-called “oneDRAM” commercially offered by Samsung Electronics Co., Ltd. and widely understood by those skilled in the art. The oneDRAM is a fusion memory chip capable of greatly increasing the data processing speed between a communication processor and a media processor in a mobile device. Previously, two processors required separate dedicated memories, but the oneDRAM is to be able to route data between processors through a single memory chip. The oneDRAM can greatly reduce the time required to communicate (i.e., transfer) data between processors by employing a dual-port approach.

Hence, a single oneDRAM may replace two or more mobile memory chips within a high-performance smart-phones and other multimedia rich-handset. As the data processing speed between processors increases, the oneDRAM allows power consumption to be reduced by approximately 30%, and the overall number of chips used to implement such host devices can be reduced to save up to 50% of available die area. As a result, the speed of cellular phone can increase approximately five times, the life of a powering battery may be prolonged, and the size (particularly the thickness) of incorporating handsets may be reduced.

It is now further assumed that the multiport DRAM 400 of FIG. 2 includes a memory cell array having four memory banks. A defined first bank is accessed by only the first processor 100. Defined third and fourth memory banks are accessed by only the second processor 200, while a defined second memory bank is accessed by both the first and second processors 100 and 200, albeit through different data ports.

When the first processor 100 accesses the second memory bank, a path controller 50 associated with the multiport DRAM 400 couples the second memory bank to system bus B1. During periods when the first processor 100 is accessing the second memory bank, the second processor 200 may access the third or fourth memory banks. When the first processor 100 is not accessing the second memory bank, the second processor 200 may access the second memory bank.

In the system architecture of FIG. 2, the first processor 100 is assumed to exclusively execute a communication application 90 providing certain MODEM functions. Thus, the first processor 100 is not available to execute any other applications, other than communication application 90. Such computationally heavy applications, such as operating a digital still camera (DSC), a video camera, or an MP3 player, must be executed using only the resources provided by the second processor 200. The idle first processor 100 is a wasted system resource.

As the diversity and number of applications placed upon a multiprocessor system increase, the computational load placed on the application processor becomes disproportionately heavy, and the communications processor may become increasingly idle. Yet, conventional multiprocessor systems are not readily changeable in their execution characteristics related to various functions or applications to be executed.

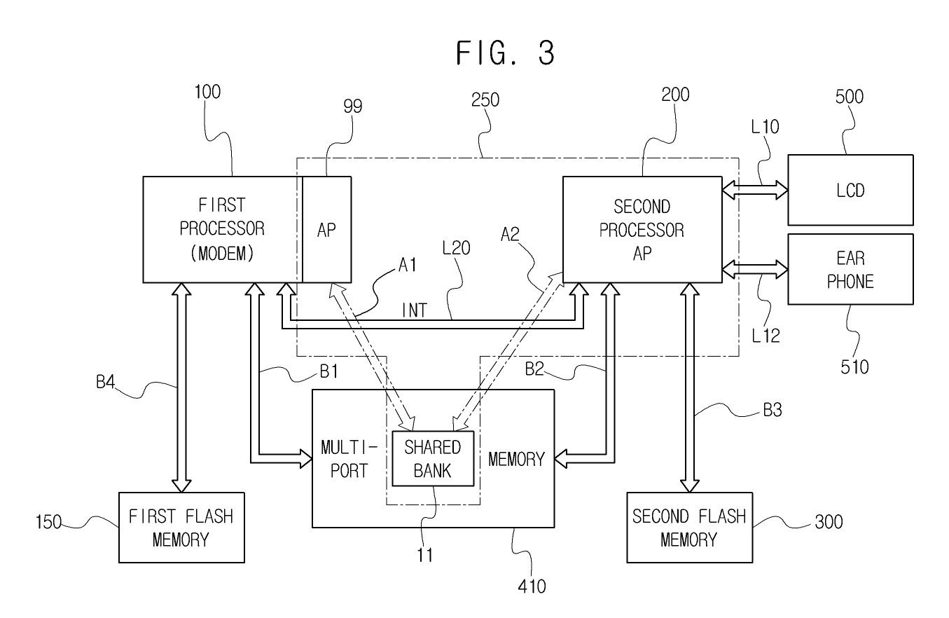

Accordingly, in an embodiment of the inventive concept, a multiport system, such as the one illustrated in FIG. 3, is configured with an open operating system (OS). This type of open operating system enables greater flexibility in the execution of various applications by multiple processors within the system.

FIG. 3 is a block diagram of multiprocessor system according to an embodiment of the inventive concept. In FIG. 3, the first processor 100 is indirectly coupled to the second processor 200 through a multiport memory 410, such as a oneDRAM. However, an application being run on the second processor 200 may “call” (i.e., invoke) the resources provided by the first processor 100. Thus, an application 99 running on first processor 100 may be opportunistically used to supplement the resources of the second processor 200. In this manner, the combination of first and second processors 100 and 200 may mimic a type of a dual core CPU.

In FIG. 3, an architecture or connection structure is illustrated between the first and second processors 100 and 200, the multiport memory 410 having a shared bank 11, and first and second flash memories 150 and 300. Additionally, a display (LCD) 500 and an earphone 510 are shown coupled to the second processor 200 via respective signal lines L10 and L12.

The first processor 100 essentially remains a dedicated communications processor and exclusively (i.e., to the exclusion of the second application processor 200) executes application(s) requiring the communications specialized circuits and resources. Indeed, in certain embodiments of the inventive concept, the first processor 100 will prioritize all communication function execution using application 99. The second processor 200 may be subordinated to the first processor 100 in operation in certain embodiments.

An interrupt line L20 is coupled between the first and second processors 100 and 200. The first processor 100 is coupled to the first flash memory 150 via bus B4. The second processor 200 is coupled to the second flash memory 300 via a bus B3.

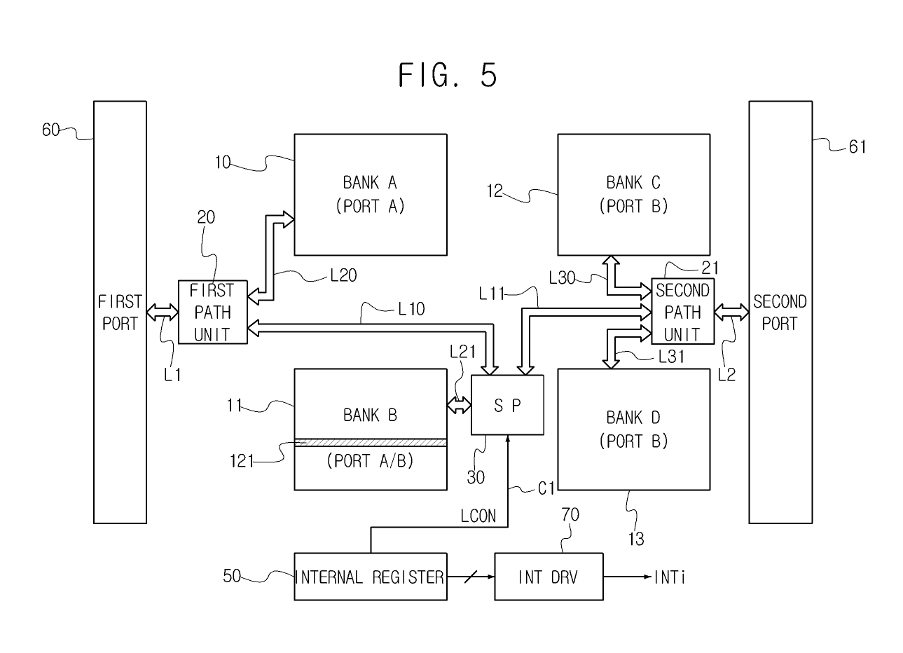

The multiport memory 410 is respectively coupled to the first and second processors 100 and 200 via buses B1 and B2, and includes a designated shared memory bank 11 commonly accessible by the first and second processors 100 and 200 through different data ports. An internal register 50 (see, FIG. 5) may be used to grant access authority to the shared memory bank 11 by the first and second processors 100 and 200.

Boot code for the first processor 100 may be stored in the first flash memory 150, and boot code for the second processors 200 may be stored in the second flash memory 300. Such “boot code” may include respective first and second boot loader programs, such as a master boot recorder (MBR), an NT Loader (NTLDR), or grand unified bootloader (GRUB) associated with a constituent OS for one or both processors.

The first boot loader may be in an assembly language, and the first processor 100 may perform a reset function by reading the first boot loader. A register of memory controller may be determined by this reset execution, and the speed of system clock is determined, and the UART is reset. In contrast, the second boot loader may be written in a higher level language, such as “C” that requires processor reset at higher level above the low level reset provided by the assembly first boot loader. In certain embodiments, the second boot loader may constitute an operating program (OS). After the second boot loader transfers control authority to the OS, the functionality of the boot loader(s) is no longer required.

In FIG. 3, during the execution of one or more application functions by the second processor 200, the first processor 100 may be called upon to execute certain functions, since the first and second processors 100 and 200 operate in an open OS format. Hence, the first processor 100 is merely another OS callable resource and may be used to perform computational functions on data passed through the multiport memory device 410.

A functional block 250 (dotted line in FIG. 3) conceptually indicates a working dual core processor executing in parallel different application functions using multiple processors.

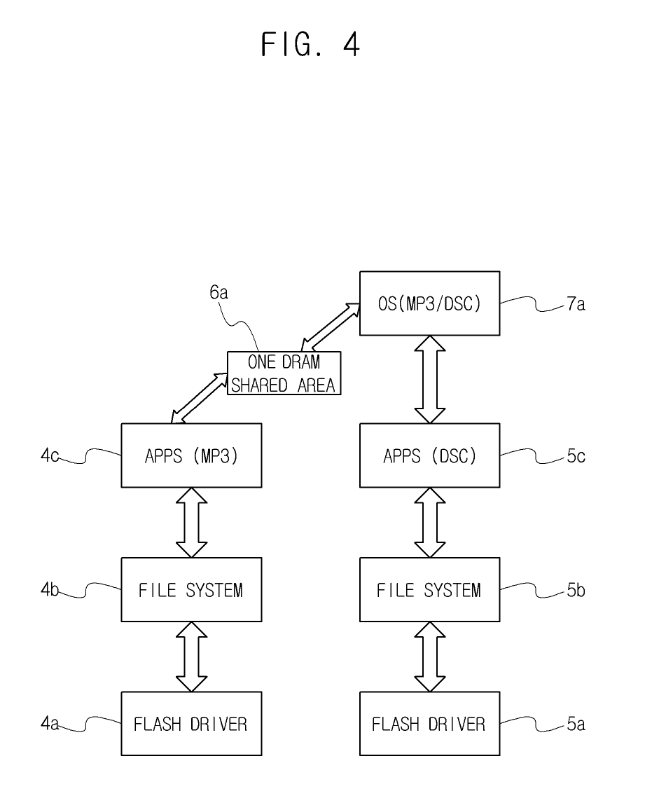

FIG. 4 illustrates an exemplary, hierarchical structure for operating system code susceptible for use within the multiprocessor system of FIG. 3.

With reference to FIG. 4, an open OS 7a resides at the top of the executable software code. The OS 7a may be invoked to directly execute a second application 5c running on the second processor 200, and to indirectly execute (through shared memory bank 6a) a first application 4c using the resources of the first processor 100. Further down the software hierarchy, the first application 4c may invoke a file system 4b resident on the first processor 100 and/or a flash driver 4a associated with the first flash memory 150. In similar manner, the second application 5c may invoke a file system 5b resident on the second processor 200 and/or a flash driver 5a associated with the second flash memory 300.

FIG. 5 is a block diagram illustrating the multiport memory of FIG. 3 in some additional detail. In FIG. 5, first and second ports 60 and 61 constitute port units. The port units are individually coupled to respectively corresponding processors 100 and 200.

The multiport memory 410 is coupled to first and second processors 100 and 200 via system buses B1 and B2, respectively. (See, FIG. 3) The multiport memory 410 comprises a conventional memory cell array logically divided onto four memory banks. A defined first memory bank (A) 10 serves as a dedicated memory for first processor 100. Defined third and fourth memory banks (C and D) 12 and 13 serve as dedicated memory banks for the second processor 200. In contrast, a defined second bank (B) 11 serves as a shared memory bank that may be commonly accessed by the first and second processors 100 and 200. That is, the second memory bank (B) 11 in the embodiment of FIG. 5 serves as the shared memory bank 11 of FIG. 3.

The dedicated memory banks 10, 12 and 13 and the shared memory bank 11 may all be implemented using DRAM cells. The four memory areas 10, 11, 12 and 13 may be individually configured as a bank unit of DRAM. One bank may have a memory storage of, i.e., 16 Mb (Megabit), 32 Mb, 64 Mb, 128 Mb, 256 Mb, 512 Mb or 1024 Mb.

Internal register 50 within the multiport DRAM 410 may serve as a path controller. The internal register 50 controls a switching unit 30, such that the second memory bank 11 is coupled to the bus B1 when the first processor 100 accesses the second memory bank 11, or is coupled to the bus B2 when the second processor 200 accesses the second memory bank 11.

The shared memory bank 11 may be commonly accessed by either processor via either port unit, and may be assigned any reasonable size (or portion of the memory cell array).

The internal register 50 functioning as a path control unit controls a data path between the shared memory bank 11 and the port units 60 and 61 via switching unit 30 in order to transfer data between the first and second processors 100 and 200 using the shared memory bank 11 as a mailbox of sorts. When a specific address accessing a specific area 121 of the shared memory bank 11 is received, the internal register 50 is accessed instead of the specific area of the shared memory bank 11 outside the memory cell array.

Switching unit 30 is coupled to the internal register 50 as the path control unit, and in response to a switching control signal LOON applied through a control line C1, the shared memory bank 11 is operationally coupled to the first path unit 20 or second path unit 21.

As a result, when the first processor 100 coupled to first port 60 accesses the shared memory bank 11, lines L1, L10 and L21 adapted among the first path unit 20, switching unit 30 and shared memory bank 11 are operationally coupled with one another.

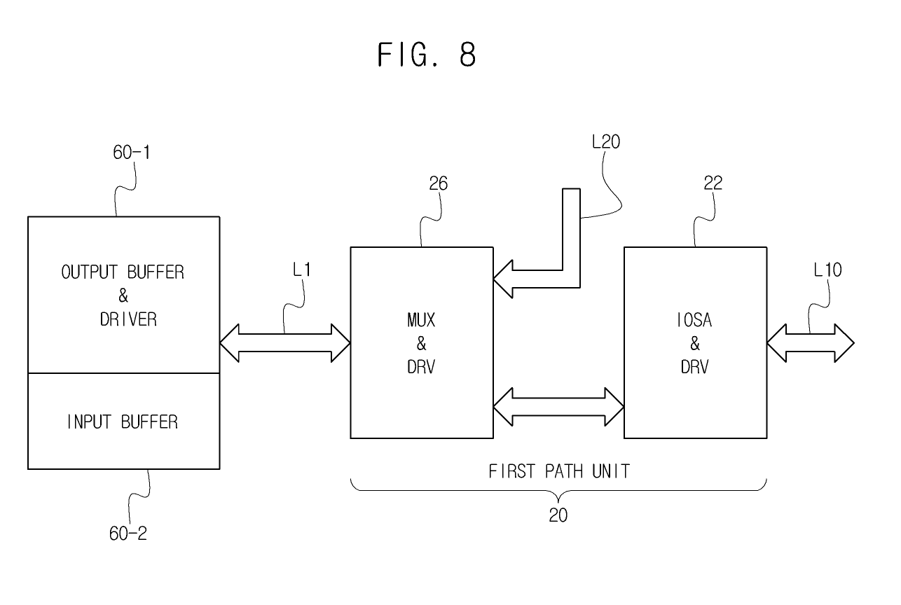

In FIG. 5, the first path unit 20 has a basic function of switching a line L1 to one of input/output lines L10 and L20, and may be comprised of an input/output sense amplifier and driver 22 and a multiplexer and driver 26 as shown in FIG. 8. Similarly, the second path unit 21 has a basic function of switching a line L2 to one of input/output lines L30, L11 and L31, and may be comprised of input/output sense amplifier and driver 22 and multiplexer and driver 26 as shown in FIG. 8.

An interrupt driver 70 may be coupled to the internal register 50 and used to apply a processor interrupt signal INTi to either respective processor.

In the illustrated embodiment, the first processor 100 serves as a MODEM processor performing all predetermined tasks associated with data communication. The second processor 200 serves as a more application processor.

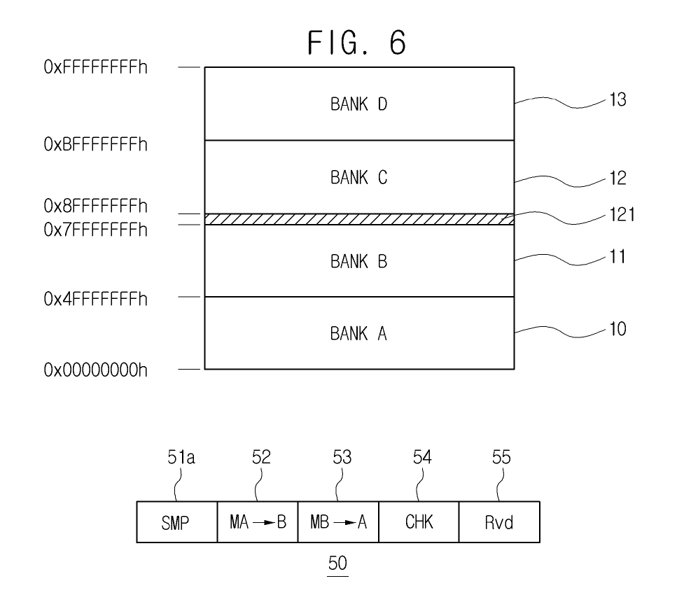

FIG. 6 provides an address assignment and substitutive access relation of internal register and memory banks referred to in FIG. 5.

As illustrated in FIG. 6, it is assumed that respective banks 10-13 have a size of 16 megabits, a specific area of the shared memory bank, 11 may be designated as a disable area 121. That is, a specific row address (0x7FFFFFFFh˜0x8FFFFFFFh, 2 KB size=1 row size) enabling one optional row of the shared memory bank 11 is assigned to access internal register 50 functioning as path control and interface unit. Then, when the specific row address (0x7FFFFFFFh˜0x8FFFFFFFh) is received, a corresponding specific word line area 121 of the shared memory bank 11 is disabled, but the internal register 50 is enabled. As a result, a semaphore area 51a and mailbox areas 52 and 53 may be accessed using a direct address mapping scheme. Thus, a specified command corresponding to the disabled address may be conventionally decoded to implement a mapping operation to an internal register outside of the memory cell array. Thus, a memory controller in a chip set driven by the system processors may issue a command to the disable area (and internal register 50) in the same method as other memory addresses.

In FIG. 6, access authority information for the shared memory bank 11 is stored in the semaphore area 51a. A message, (i.e., authority request, address, data size, transmission data indicating an address of shared memory having storage data, or commands, etc.,) transmitted to mutual corresponding processors from the first and second processors 100 and 200, is written to mailbox areas 52 and 53. That is, a message transmitted from the first processor 100 to the second processor 200 is written to the mailbox area 52, and a message transmitted from the second processor 200 to the first processor 100 is written to the mailbox area 53.

The semaphore area 51a and mailbox areas 52 and 53 may be each assigned with 16 bits, and the check bit area 54 may be assigned with 4 bits. A reserve area 55 may be assigned with 2 bits as a preliminary area.

The areas 51a, 52, 53, 54 and 55 may be enabled in common by the specific row address, and may be individually accessed depending on an applied column address.

Consequently, the internal register 50 is a data storage area adapted specifically from the memory cell array area, for an interface between processors. The internal register 50 is accessed by all of the first and second processors, and may be comprised of a flip-flop and a data latch. That is, the internal register 50 may be implemented as a configuration of latch type storage cells different from the memory cells forming the memory cell array. Such latch type storage cells, unlike DRAM memory cells, do not require refresh.

For example, when a data interface between the first and second processors 100 and 200 is obtained through multiport DRAM 410, the first and second processors 100 and 200 may write a message to be transmitted to a corresponding processor by using the mailboxes 52 and 53. A processor of a receiving party having read the written message recognizes the message of the transmission-party processor and performs its corresponding operation.

For example, when the second processor 200 of FIG. 3 transfers access authority over the shared memory bank 11 of the multiport memory 410 to the first processor 100, the second processor 200 changes first flag data ‘1’ in the semaphore area 51a shown in FIGS. 6 to ‘0’, and then writes a message to inform that the access authority is changed, to the mailbox 52. Then, after a lapse of given time, second flag data of the semaphore area 51a is automatically changed from ‘0’ to ‘1’. Accordingly, access authority over the shared memory bank 11 is transferred to the first processor 100. The first processor 100 having received the message from the mailbox 52 regarding transfer of access authority, confirms as to whether the second flag data of the semaphore area 51a has been changed to ‘1’. After confirming the change of the second flag data to ‘1’, the first processor 100 writes a response message to inform a receipt of the access authority to the mailbox 53. Then, the first processor 100 exclusively has the access authority for the shared memory bank 11 until an authority request of the second processor 200 is given or the task of the first processor itself 100 is completed.

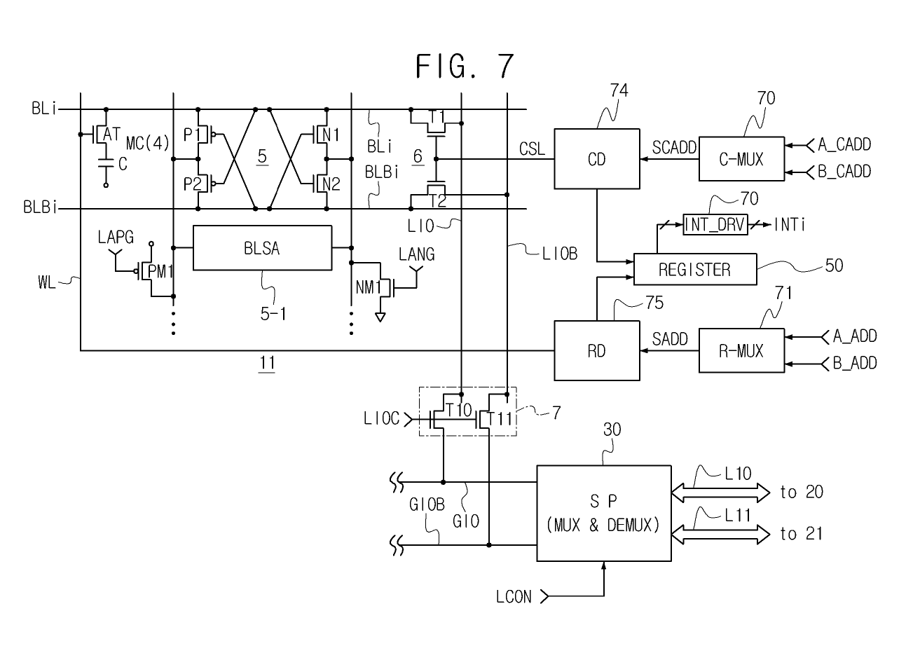

FIG. 7 is a circuit diagram illustrating in detail an example of multipath accessing to shared memory bank shown in FIG. 5. FIG. 8 is a block diagram illustrating a detailed coupling example between a first port unit and a first path unit referred to in FIG. 5, including an input/output sense amplifier and driver 22 and a multiplexer and driver 26.

Referring to FIG. 7, a DRAM memory cell 4 belongs to the shared memory bank 11. The shared memory bank 11 is shown being operationally coupled to one of the first and second path units 20 and 21 referred to in FIG. 5 through a switching operation of switching unit 30.

In the shared memory bank 11, the DRAM memory cell 4 comprises an access transistor AT and a storage capacitor C forming a single bit memory unit. The DRAM memory cell 4 is coupled at the intersection of a word line WL and a bit line BL which are part of a larger matrix of word and row lines. The word line WL shown in FIG. 7 is disposed between a gate of access transistor AT of the DRAM memory cell 4 and a row decoder 75. The row decoder 75 applies a row decoded signal to the word line and the register unit 50 in response to a selection row address SADD of row address multiplexer 71. A bit line BLi constituting a bit line pair is coupled to a drain of the access transistor AT and a column selection transistor T1. A complementary bit line BLBi is coupled to a column selection transistor T2. PMOS transistors P1 and P2 and NMOS transistors N1 and N2 coupled to the bit line pair BLi, BLBi constitute a bit line sense amplifier 5. Sense amplifier driving transistors PM1 and NM1 drive the bit line sense amplifier 5 by individually receiving a drive signal LAPG, LANG. A column selection gate 6 comprised of column selection transistors T1 and T2 is coupled to a column selection line CSL transferring a column decoded signal of a column decoder 74. The column decoder 74 applies a column decoded-signal to the column selection line and the register unit 50 in response to a selection column address SCADD of column address multiplexer 70.

In FIG. 7, a local input/output line pair LIO, LIOB is coupled to a first multiplexer 7. When transistors T10 and T11 constituting the first multiplexer 7 are turned on in response to a local input/output line control signal LIOC, the local input/output line pair LIO, LIOB is coupled to a global input/output line pair GIO, GIOB. Then, data of the local input/output line pair LIO, LIOB is transferred to the global input/output line pair GIO, GIOB in a read operation mode of data. On the other hand, in a write operation mode of data, write data applied to the global input/output line pair GIO, GIOB is transferred to the local input/output line pair LIO, LIOB. The local input/output line control signal LIOC may be a signal generated in response to a decoded signal output from the row decoder 75.

Read data transferred to the global input/output line pair GIO, GIOB is transferred to a corresponding input/output sense amplifier and driver 22 through one of lines L10 and L11 as shown in FIG. 8. The input/output sense amplifier 22 serves as again amplifying data having a weak level in the transfer steps of several data paths. Read data output from the input/output sense amplifier 22 is transferred to first port 60 through multiplexer and driver 26 as shown in FIG. 8, the multiplexer and driver 26 and the input/output sense amplifier 22 constituting a first path unit 20. When it is the state that the shared memory bank 11 is accessed by the first processor 100, the second processor 200 is disconnected from the line L11, thus an access operation of the second processor 200 to the shared memory bank 11 is intercepted. But, in this case, the second processor 200 can access the dedicated memory areas 12 and 13 through second port 61.

In write operation, write data applied through the first port 60 is transferred to the global input/output line pair GIO, GIOB of FIG. 7 sequentially through an input buffer 60-2, multiplexer and driver 26, input/output sense amplifier and driver 22 and the switching unit 30 referred to in FIG. 8. When the first multiplexer 7 is activated, the write data is transferred to local input/output line pair LIO, LIOB and stored in a selected memory cell 4.

An output buffer and driver 60-1 and input buffer 60-2 shown in FIG. 8 may correspond to or be included in the first port 60 of FIG. 5. The input/output sense amplifier and driver 22 and the multiplexer and driver 26 may correspond to or be included in first path unit 20 of FIG. 5. The multiplexer and driver 26 prevents one processor from simultaneously accessing the shared memory bank 11 and dedicated memory area 10.

As described above, in the multiport memory 410 according to an embodiment of the inventive concept having a structure similar to that of FIG. 7, respective processors may commonly access shared memory bank 11, thus a plurality of application functions may be dispersed over the collective resources of multiple processors using an open operating system.

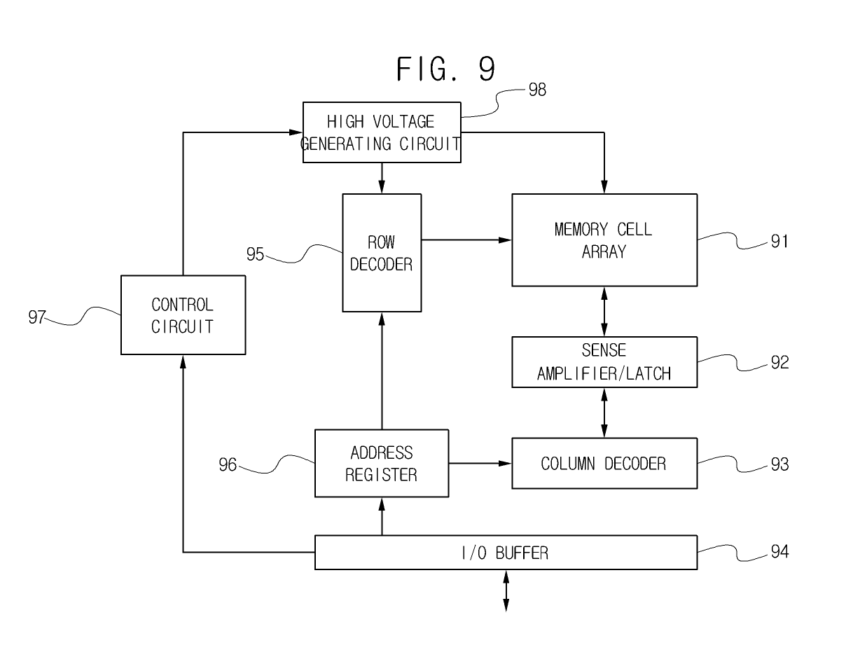

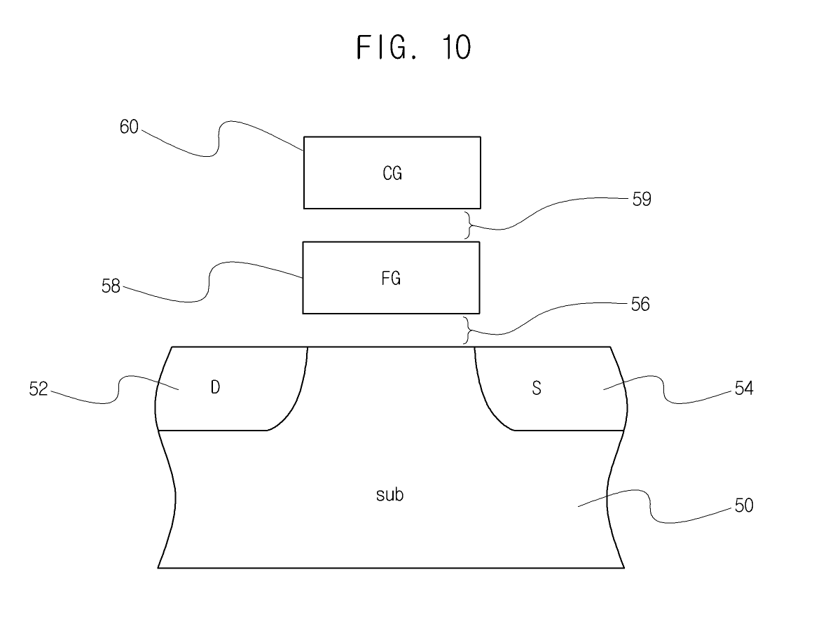

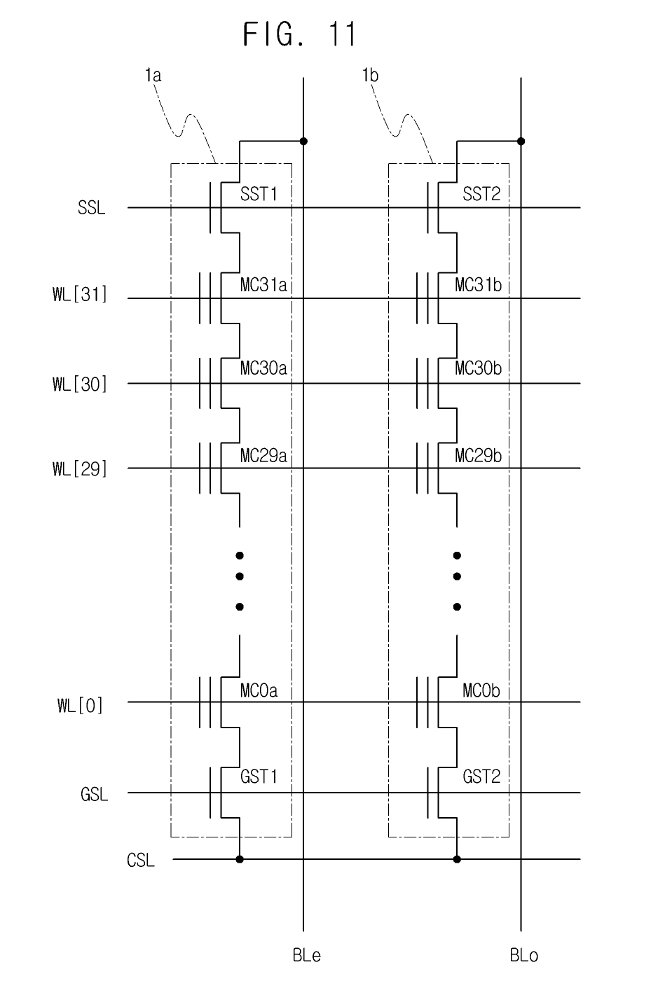

FIG. 9 is a block diagram further illustrating the nonvolatile memory device(s) of FIG. 3. FIG. 10 illustrates the structure of a unit memory cell constituting the memory cell array of FIG. 9. FIG. 11 illustrates an example of NAND memory cell array.

Device blocks shown in FIG. 9 may be provided as a circuit block of general nonvolatile semiconductor memory device.

In FIG. 9 there are a block connection structure of NAND type flash EEPROM including a memory cell array 91, sense amplifier and latch 92, column decoder 93, input/output buffer 94, row decoder 95, address register 96, high voltage generating circuit 98 and control circuit 97. The sense amplifier and latch 92 may sense and store input/output data of memory cell transistors, and the column decoder 93 may select bit lines, and the row decoder 95 may select word lines. The address register 96 may store addresses, and the high voltage generating circuit 98 may generate high voltage higher than operation power voltage for a program or erase operation. The control circuit 97 may overall control an operation of nonvolatile semiconductor memory.

The flash memory device having the structure like in FIG. 9 corresponds to first flash memory 150 shown in FIG. 3. A second flash memory 300 comprises blocks referred to in FIG. 9 in another chip. Meanwhile, the first and second flash memories 150 and 300 may be realized in a multichip package, or may be configured as one chip in a support of data interface and boot interface of the multiport memory 410.

The memory cell array 91 may be configured in a NAND type as shown in FIG. 11. That is, FIG. 11 is an equivalent circuit diagram illustrating a connection structure in memory cells of the memory cell array 91. The memory cell array 91 comprises a plurality of cell strings (NAND cell units), but for a reference in the drawings, a first cell string 1a connected to an even bit line BLe and a second cell string 1b connected to an odd bit line BLo are just shown.

The first cell string 1a comprises a string selection transistor SST1 whose drain is connected to bit line BLe, a ground selection transistor GST1 whose source is coupled to a common source line CSL, and a plurality of memory cell transistors MC31a, MC30a, . . . , MC0a whose drain-source channels are connected in series between a source of the string selection transistor SST1 and a drain of the ground selection transistor GST1. Similarly, the second cell string 1b comprises a string selection transistor SST2 whose drain is connected to a bit line BLo, a ground selection transistor GST2 whose source is coupled to a common source line CSL, and a plurality of memory cell transistors MC31b, MC30b, . . . , MC0b whose drain-source channels are connected in series between a source of the string selection transistor SST2 and a drain of the ground selection transistor GST2.

A signal applied to a string selection line SSL is supplied in common to gates of the string selection transistors SST1 and SST2, and a signal applied to a ground selection line GSL is supplied in common to gates of the ground selection transistors GST1 and GST2. Word lines WL0-WL31 are coupled equivalently in common to control gates of memory cell transistors belonging to the same row. Bit lines BLe and BLo operationally connected to the sense amplifier and latch 92 of FIG. 9 are disposed being crossed to the word lines WL0-WL31 on different layers, and the bit lines are disposed in parallel with each other on the same layer.

An optional memory cell transistor shown in FIG. 11 is comprised of MOS transistor having a floating gate 58 below a control gate 60 as shown in FIG. 10.

Operations of unit memory cell comprised of MOS transistor having a charge-storage floating gate are described in brief as follows, as illustrated in FIG. 10.

In operations of a NAND-type EEPROM, erase, write and read operations are described as follows. The erase and program (write) operation can be obtained by using an F-N tunneling current. For example, in the erase, a very high potential is applied to a substrate 50 shown in FIG. 10 and a low potential is applied to the CG (Control Gate) 60 of memory cell transistor. In this case, potential decided by a coupling ratio for a capacitance between CG and a floating gate (FG) 56 and a capacitance between the FG 58 and the substrate 50 is applied to the FG 58. When a potential difference between a floating gate voltage Vfg applied to the FG 58 and a substrate voltage Vsub applied to the substrate 50 is greater than a potential difference capable of creating an F-N tunneling, electrons gathered in the FG 58 move from the FG58 to the substrate 50. Such operation lowers a threshold voltage Vt of a memory cell transistor comprised of CG 60, FG 58, a source 54 and a drain 52. Since the Vt is sufficiently lowered, even when 0 V is applied to the CG 60 and the source 54 and a positive low-voltage is applied to the drain 52; current flows and this is decided as having “ERASE” and may be logically represented as ‘1’.

Meanwhile, in the write (program) operation, 0V is applied to source 54 and drain 52 and a relatively very high voltage is applied to CG 60. At this time, an inversion layer is formed in a channel region and the source and drain both have a potential of 0V. When a potential difference between Vfg decided by a rate of capacitances between CG and FG and between FG and the channel region, and Vchannel (0 V), becomes great enough to create the F-N tunneling; electrons move from the channel region to the FG 58. At this time, Vt increases, and when a predetermined positive voltage is applied to the CG 60, 0V is applied to the source 54, and a positive low-voltage is applied to the drain 52; current does not flow and this is decided as having “PROGRAM” and may be indicated as a logic ‘0’.

In a memory cell array having a plurality of cell strings such as the first and second cell strings, a unit of page indicates memory cell transistors for which control gates are connected in common to the same word line. A plurality of pages including a plurality of memory cell transistors are provided as a cell block, and one cell block unit generally includes one or plurality of cell strings per bit line. A NAND flash memory has a page program mode for a high speed programming. A page program operation is classified as a data loading operation and a program operation. The data loading operation is to sequentially latch and store data of a byte magnitude in data registers from input/output terminals. Data registers are adapted corresponding to respective bit lines. The program operation is to write at one time data stored in the data registers, to memory transistors on a word line selected through bit lines.

In the NAND-type EEPROM described above, read operation and program operation are generally performed by a unit of page, and erase operation is performed by a unit of block. Actually, a movement of electrons between a channel and an FG of the memory cell transistor is performed just in program and erase operations, and in read operation, an operation of just reading intact data stored in memory cell transistor without damaging the data is performed after the erase and program operation are completed.

In the read operation, a voltage (generally, read voltage) higher than a selection read voltage Vr applied to CG of a selected memory cell transistor is applied to a non-selected CG of memory cell transistor. Then, current flows or does not flow through a corresponding bit line according to a program state of the selected memory cell transistor. When a threshold voltage of a programmed memory cell is higher than a reference value in a predetermined voltage condition, the memory cell is decided as an off-cell, thus charging a corresponding bit line to voltage of a high level. To the contrary, when a threshold voltage of programmed memory cell is lower than the reference value, the memory cell is decided as an on-cell, and a corresponding bit line is discharged to a low level. This state of the bit line is finally read out as ‘0’ or ‘1’ through a sense amplifier called the page buffer.

Memory cell transistors of the cell string initially have an erase operation to have a threshold voltage of, i.e., approximately −3V or below. And then, when to program a memory cell transistor, a high voltage is applied to a word line of a selected memory cell for a given time, the selected memory cell is changed into a relatively higher threshold voltage, meanwhile, threshold voltages of memory cells not selected in programming are not changed.

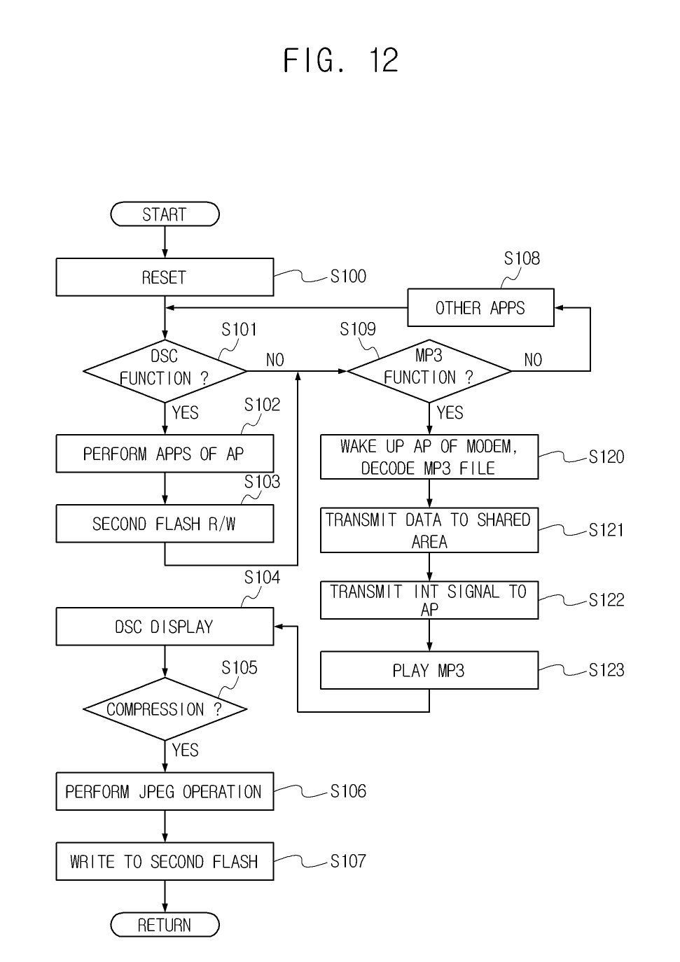

FIG. 12 is a flowchart for a control in a multi application operation referred to in FIG. 3.

Operation according to an embodiment of the inventive concept is described as follows, on the basis of FIG. 12 and referring to the accompanying drawings, just for a thorough description of the embodiment without deviating from the spirit of the invention.

Referring to FIG. 12, when power source is applied to multiprocessor system referred to in FIG. 3, a reset is performed in a step S100. In the step S100, the first and second processors 100 and 200 read a first boot loader from respectively corresponding and coupled first and second flash memories 150 and 300. The first boot loader is a program for a reset of respective processors, and may be a program, i.e., master boot recorder (MBR) etc. That is, the first and second processors 100 and 200 read the first boot loader writable in an assembly language and perform a reset of low level necessary for an operation of processor. By such reset execution a register of memory controller adapted inside a processor is determined, and the speed of system clock is determined, and a UART is also reset.

In the step S100, the first and second processors 100 and 200 read a second boot loader from the first and second flash memories 150 and 300 respectively corresponding thereto. The second boot loader is a program for operating an operation system of a processor, and may be a program, i.e., NTLDR (NT Loader) or GRUB (Grand Unified Bootloader) etc. The program may be written in a C language, and is used for performing a reset of a relatively high level on the basis of a reset environment of the low level. In the step S100, the read of boot loader indicates a reading of data stored in a floating gate 58 of FIG. 10. The details for the reading operation have been described above with reference to FIGS. 9 to 11.

When a party of the second processor 200 has an open operation system, the second processor 200 reads software, i.e., open operation system (OS), shared by the first and second processors 100 and 200, stored in a predetermined-storage area of the second flash memory 300, thus completing a booting and set operation.

In the embodiment of the inventive concept, a work load should be dispersed per processor at an operation system level, thus a scheduling function of managing a work load and a function for an interrupt processing based on a work load completion are added.

Utilization for all application functions of respective processors is described as follows under an assumption that in a use of handheld phone for FIG. 3, photo data is stored in second flash memory 300 by a DSC and MP3 data is stored in first flash memory 150.

In FIG. 12, it is checked in a step S101 whether to be a DSC function or not. When the DSC function is required by a user in the step S101, an application function of second processor 200 is performed in a step S102. The second processor 200 processes DSC data obtained from an image sensor and accesses the second flash memory 300 to write the data. As described above, when a requirement for the MP3 function is provided to the system in a step S109, a check for the MP3 function is passed in a step S120.

In the step S120, through the scheduling function of the open operation system, a processing related to the execution of MP3 function is decided to be processed by an AP 99 of the first processor 100, thus the AP 99 of the first processor 100 as the MODEM processor is woken and an MP3 file is decoded. As a result, the function like the processing through a dual core CPU is attained under the support of a memory 410. When the first processor 100 completes a decoding for the MP3 file stored in the first flash memory 150, the decoding-completed data is transmitted to the shared bank 11 of the multiport memory 410 in a step S121. Furthermore, the first processor 100 transmits an interrupt signal INT to the second processor 200 through a line L20 in a step S122. At this time, the access authority for the shared memory bank 11 shown in FIG. 5 is transferred from the first processor 100 to the second processor 200. The authorization and the transfer of access authority for the shared memory bank 11 have been already described above with reference to FIGS. 5 to 8.

In response to that, accordingly, the second processor 200 performs a step S123. In the step S123, the second processor 200 receives the decoding-completed MP3 file through the shared bank 11 and provides the file to an earphone block 510, thereby replaying an MP3. Consequently, the decoding process of the MP3 file may be implemented by utilizing the AP 99 of the first processor 100. Accordingly, the second processor 200 can fast perform the next operations including a step S104 in a state that a process burden of an application function is loosened.

Photo data of DSC is displayed on a liquid crystal display 500 in the step S104 of FIG. 12. Then, user can see the photo data with his/her eyes through the liquid crystal display in a state of hearing music through the playback of MP3 file.

On the other hand, when an auto-compression storage command or compression requirement is entered in a step S105, the second processor 200 performs a JPEG operation in a step S106. Data compressed in the step S106 is written to the second flash memory 150. The write operation indicates an operation of storing the data to FG 58 referred to in FIG. 10, and the detailed procedure for the write operation as a program operation has been already described above referring to FIGS. 9 to 11.

As described above, according to certain embodiments of the inventive concept, a system performance in a multiprocessor system is substantially enhanced by utilizing respective processors to execute application functions using a multiport memory as an interface. That is, a data processing performance can be obtained like in the configuration with processors of a high-end level, even when employing processors of a mid-end level, thereby more lowering system implementation expenses and obtaining a relatively compacted-size of the system.

In a multiprocessor system according to an embodiment of the inventive concept, the number of processors may increase to three or more. In the multiprocessor system, the processor may be a microprocessor, CPU, digital signal processor, micro controller, reduced-command set computer, complex command set computer, or the like. Meanwhile, it is noted herein that the scope of the inventive concept is not limited to the number of processors in the system. The scope of the inventive concept is not limited to any special combination of processors in adapting the same or different processors as the embodiments described above.

It will be apparent to those skilled in the art that modifications and variations can be made in the present invention without deviating from the scope of the inventive concept. Thus, it is intended that the inventive concept cover any such modifications and variations of this invention provided they come within the scope of the appended claims and their equivalents.

For example, in other cases, a memory link structure or an operating sequence of processors, the structure of shared memory bank of a multiport semiconductor memory, the structure of semaphore and mailbox in an internal register, or the structure of circuit and an access method may be changed diversely, without deviating from the scope of the inventive concept.

Furthermore, although the system booting is performed principally by an ASIC processor, the system booting may be performed by other processors, and in addition, an implementation of a data path control to control a data path between the port units and the shared memory bank of the oneDRAM may be obtained in various kinds of methods. Although the structure of semaphore using an internal register is described above as the example, the technology of the inventive concept may be applied extendedly to other nonvolatile memories of PRAM etc. without limiting to the above-description.

Accordingly, these and other changes and modifications are seen to be within the true spirit and scope of the inventive concept as defined by the appended claims.

In the drawings and specification, there have been disclosed typical embodiments of the inventive concept and, although specific terms are employed, they are used in a generic and descriptive sense only and not for purposes of limitation, the scope of the inventive concept being set forth in the following claims.

What is claimed is:

1. A multiprocessor system comprising:
first and second processors independently executing application functions associated with one or more applications using an open operating system (OS);
a multiport memory comprising:
a memory cell array divided into a plurality of memory banks including a shared memory bank commonly accessed by the first and second processors via respective first and second ports, and
an internal register disposed outside the memory cell array and configured to control access authority to the shared memory bank by the first and second processors; and
a first nonvolatile memory coupled to the first processor via a first bus and a second nonvolatile memory coupled to the second processor via a second bus,
wherein different application functions are independently executed in parallel by the first and second processors using the multiport memory as a data transfer mechanism.

2. The system of claim 1, wherein the first processor is a MODEM processor exclusively executing a communication application.

3. The system of claim 2, wherein the second processor is an application processor executing at least one application associated with an image display, a digital still camera, or an MP3 file playback.

4. The system of claim 2, wherein the first processor executes an application function in response to message communicated from the second processor via the shared memory bank of the multiport memory.

5. The system of claim 2, wherein the communication application enable execution of a data modulation/demodulation function.

6. The system of claim 3, wherein the at least one application comprises an application function enabling at least one application function including a movie file playback, message edition, digital still cameral image display and an MP3 file playback.

7. The system of claim 1, wherein the internal register comprises a semaphore area configured to store access authority information, and mailbox areas configured to store request information and a message related to an access authority request.

8. The system of claim 1, wherein the multiport memory further comprises:
a dedicated memory bank accessed by only the first processor or the second processor.

9. The system of claim 1, wherein the first and second nonvolatile memories are flash memory.
